(19) United States
(12) Patent Application Publication
(10) Pub. No.: US 2023/0247945 A1
(43) Pub. Date: Aug. 10, 2023

(54) WEATHER MANAGEMENT OF CYCLONIC EVENTS

(71) Applicant: Lawrence Sirovich, New York, NY (US)

(72) Inventor: Lawrence Sirovich, New York, NY (US)

(21) Appl. No.: 18/191,842

(22) Filed: Mar. 28, 2023

Related U.S. Application Data
(63) Continuation of application No. 17/589,775, filed on Jan. 31, 2022, now abandoned.
(63) Continuation of application No. 17/150,931, filed on Jan. 15, 2021, now abandoned.
(63) Continuation-in-part of application No. 16/778,679, filed on Jan. 31, 2020, now abandoned.

(51) Int. Cl. A01G 15/00

(52) U.S. Cl. CPC A01G 15/00

(57) ABSTRACT

A method of mitigating the formation of a hurricane comprising the steps of, upon detection of a tropical depression dispatching, to the center of a disturbance, a plurality of vessels modified for stirring and mixing of ocean water. The vessels undertake a cyclonic annular track at the center of the disturbance that will enhance the cooling of the ocean surface layer and reduce ocean spray therefore interfere with hurricane production, and continuing said activity while following said center of said disturbance until the threat of a hurricane is eliminated. A similar method may be used to promote the formation of a hurricane causing said plurality of vessels to undertake an anti-cyclonic circulation annular track to enhance a Coriolis inflow of warm surface water and the increase in ocean spray in order to directly promote hurricane production.

### CROSS-REFERENCE TO RELATED APPLICATION

This application is a continuation-in-part of U.S. Application 17/589,775, filed on Jan. 31, 2022 which is 17/150,931, filed on Jan. 15, 2021 which was a continuation-in-part (CIP) of U.S. Pat. Application No. 16/778,679 filed on Jan. 31, 2020 which was related to U.S. Pat. Application No. 13/610,345 filed on Sep. 11, 2012 issued as U.S. Pat. No. 9,078,402 on Jul. 14, 2015, that was a continuation-in-part (CIP) of U.S. Pat. application No. 11/317,062 filed on Dec. 22, 2005 issued as Pat. No. 8,262,314 on Sep. 11, 2012; and, all of which are incorporated as if fully set forth herein.

### BACKGROUND OF THE INVENTION

### 1. Field of the Invention

The present invention generally relates to the field of weather modification and, more specifically, to weather management of cyclonic events.

### 2. Description of the Prior Art

The images of devastation to the Bahamas by hurricane Dorian reveal, in compelling fashion, the economic and human costs of hurricanes. It has been estimated that, in future, economic costs will rise to between $10 billion and $10 trillion dollars per year. Hurricane Katrina, the costliest of US hurricanes, had an estimated cost of $160 billion and claimed 1600 deaths. The deadliest cyclonic even ever was the 1970 Behola cyclone reported to have taken 500,000 lives.

Presently, the best advice for escaping the devastation of hurricanes is to build stronger structures, or to have people hasten to higher ground. It is the intent of this application to shed light on feasible, practical, technologically based solutions to this global problem.

A hurricane, at a diameter of a thousand kilometers is huge, and packs the energy of 100,000 medium-sized atomic bombs (Monin 1972). It is a monster. To attempt controlling such a monster might seem a fool’s quest. Yet, it is a fact that a typical hurricane, 10 hours after making landfall, is reduced in intensity by more than a factor of ½.

Two reports “Managing the Risks of Extreme Events and Disasters to Advance Climate Change Adaptation”, Special Report of the Intergovernmental Panel on Climate Change, 2012 henceforth referred to as Managing (see NYTimes, July 10 editorial, “Heating Up) and “The Impact of Climate Change on the Hurricane Damages in the United States” (R. Mendelsohn, K. Emanuel, S. Chonabayashi, The World Bank, Finance Economics and Urban Department, Global Facility for Disaster Reduction and Recovery, 2011) henceforth referred to as Impact portend possible dire consequences of climate change. Both reports show the need for a unified long-term program to explore possibilities for diminishing the devastating consequences of tropical cyclone activity. It is the recommendation in this application and applicant’s parent application, now issued as U.S. Pat. No. 8,262,314 (“Patent”), that the techniques proposed by applicant provide viable solutions to the prevention of devastating storms and hurricanes. Impact is a wide-ranging comprehensive report based on known statistics and extensive modeling of hurricane activity in the United States. Both Impact & Managing point out that for example a Katrina is an example of a rare event, as are many extreme natural disasters, and therefore one cannot draw convincing predictions from a history of such events. But if climate change is indeed occurring, then increased incidence of such rare events is a compelling consequence.

Intense cyclonic events are global phenomena and in the United States account on average for about $10 billion/year cost in damages (Impact, 2011). In the absence of climate change, and purely on the basis of income and population growth by the year 2100 the forecast is this will rise to between $27 billion/year and $55 billion/year (Impact, 2011).

If climate change predictions are incorporated the yearly destructive costs are expected to lie between $70 billion and $120 billion by the year 2100. Additional effects such as sea level rise have not been factored into these calculations (Impact, 2011).

U.S. Pat. No. 4,470,544 and U.S. Pat. No. 5,492,274 disclose methods for mixing of sea water to achieve greater rainfall in the Mediterranean basin. Mixing layers of a large body of water increases the potential of solar energy being captured by the water and increases the intensity of storms fueled by the energy content of the seawater. The goal of both these patents is to thicken the upper ^{~}20 m warm surface layer over the course of months, by the use of surface vessels and other devices.

By contrast, U.S. Pat. Nos. 9,078,402 and 8,262,314 are directed at mixing the thermocline with the surface layer, a region ^{~}100 m, quickly, in less than one day, by submerged devices, that faced no danger by imminent hurricanes and without creating navigational obstructions. The submerged devices, namely submarines, used vertical plates or other bluff surfaces upstream of the stern creating eddy currents and turbulence surrounding the hull.

Pat. 8,262,314 demonstrates that the quantity of power needed to reduce the intensity of a fully formed hurricane by means of cooling the warm ocean surface layer on the hurricane track is not out of reach. It can be accomplished by a pack of about 10 nuclear submarines. Each submarine which may be regarded as an ocean-going power plant, of roughly the capacity seen in a small city such as Burlington Vt. The principle at work, is that the assembly of such seagoing power plants act as a heat pump, operating at a remarkably high Coefficient of Performance. Under the guidance of a calculated projected track position, with dynamical corrections, the newly cooled surface layer continually diminishes the intensity of the hurricane, with the result that may be likened to a virtual landfall.

Pat. 9,078,402 is based on the key observation, that a nuclear submarine to be used just for the purpose of ocean mixing does not require military stealth in its design. This allows for large airfoil-like fins to be constructed on the submarine for the purpose of lifting deep cold ocean water to the surface, and additionally, for mounting of extremely large propellers on the propulsion unit. These two components substantially enhance the turbulent cooling of the warm ocean layer on the predicted hurricane track. The desired effect of these measures is to reduce the intensity of the hurricane. As was demonstrated in both prior patents even a modest reduction of intensity, as measured by maximal hurricane wind speed, of 20% produces a 50% reduction in cost damage. Since future cost damage of hurricanes has been estimated to be in the range of tens of billions or tens of trillions of dollars, this becomes very significant.

Ocean spray generated by the atmospheric cyclonic vortex meeting the undisturbed ocean is the engine that drives a hurricane. The present patent application presents a practical framework for immediately dispatching vessels to the location of a potential hurricane, and executing maneuvers, which in a best-case scenario would be able to quench the potential hurricane, before it properly forms. Thus, unlike Pat’s. 8,262,314 & 9,078,402 this eliminates the accumulation of rainfall, thus avoids another significant element that causes damage and distress.

As will be demonstrated below another consequence of the present deliberations is that a corresponding reversal of the above stated procedure presents an opportunity to produce desired rainfall, when that is a goal, by bringing a suitable storm to a critical stage leading to a fully formed storm.

A shortcoming of Pat’s. 8,262,314 & 9,078,402 was that they lacked a proof of concept in terms of available evidence, and thus would lead to an expensive testing program. The present application leads to a straightforward program of computational testing of the claims, by the well-established methods of Computational Fluid Mechanics.

### SUMMARY OF THE INVENTION

The present invention is for a method of mitigating the formation of a potential hurricane comprising the steps of:
(a) on detection of a tropical depression moving in a known direction having a center and predetermined radius within which there is an atmospheric swirl in a predetermined cyclonic direction resulting in the formation of spray rising from the ocean surface into the atmosphere;
(b) dispatching a plurality of vessels modified for stirring and mixing ocean water;
(c) causing said plurality of vessels to undertake a cyclonic flow in a direction that is the same as said predetermined direction in an annular band of circulation substantially corresponding to said predetermined radius around said center of the tropical depression to cause cooling through mixing and Coriolis lift to diminish surface ocean temperature and spray rising into the atmosphere; and
(d) continuing said activity while following said center of said tropical depression along said known direction until the threat of a hurricane is eliminated.

The invention is also directed to a method of triggering the formation of a hurricane comprising the steps of:
(a) on detection of conditions conducive for storm generation or production of rainfall under circumstances of a tropical depression moving in a known direction and having a center and predetermined radius within which there is an atmospheric swirl resulting in the formation of spray rising from the ocean surface into the atmosphere in a predetermined cyclonic direction;
(b) dispatching a plurality of vessels modified for stirring and mixing ocean water;
(c) causing said plurality of vessels to undertake an anti-cyclonic flow in a direction that is in a direction that is opposite to said predetermined cyclonic direction in an annular band of circulation substantially corresponding to said predetermined radius around said center of the tropical depression to cause warm ocean water to be drawn towards the center of the tropical depression as a result of Coriolis lift to maintain the surface ocean temperature and increase ocean spray rising into the atmosphere; and
(d) continuing said activity while following said center of said tropical depression along said known direction to enhance the creation of rainfall or a storm.

### BRIEF DESCRIPTION OF THE DRAWINGS

The above and other aspects, features and advantages of the present invention will be more apparent from the following description when taken in conjunction with the accompanying drawings, in which:

FIG. 1 is a diagram depicting the water depth of the thermocline for various months of the year in an area of the North Atlantic;

FIG. 2 illustrates, in the left column, the case of the North Atlantic, with upper layer Hu = 20 m, and temperature Tu = 27° C.; the lower layer H1 = 50 m, and at a temperature T1 =20° C., and, in the right column, represents the uniformly mixed upper and lower columns. Both columns are one m² cross-section;

FIG. 3 illustrates examples of three different thermocline locations showing ocean temperature variations as they typically appear for the month of August in the Gulf of Mexico, the Caribbean and the Atlantic Ocean;

FIG. 4 illustrates, as an example, the path or course of the 1988 Hurricane Gilbert as it passed over the Yucatan Peninsula into the Gulf of Mexico before reaching the Mexico mainland;

FIG. 5 illustrates an image of the sea temperature on Sep. 12, 1988 prior to Hurricane Gilbert traversing the trajectory shown in FIG. 4;

FIG. 6 is similar to FIG. 5 but illustrates the sea temperature on Sep. 17, 1998 after Hurricane Gilbert has traversed the trajectory shown in FIG. 4 and made landfall; and

FIG. 7 Illustrates a plurality of submarines in a configuration for inducing ocean swirling, on the basis of nominal four nuclear subs.

### DETAILED DESCRIPTION

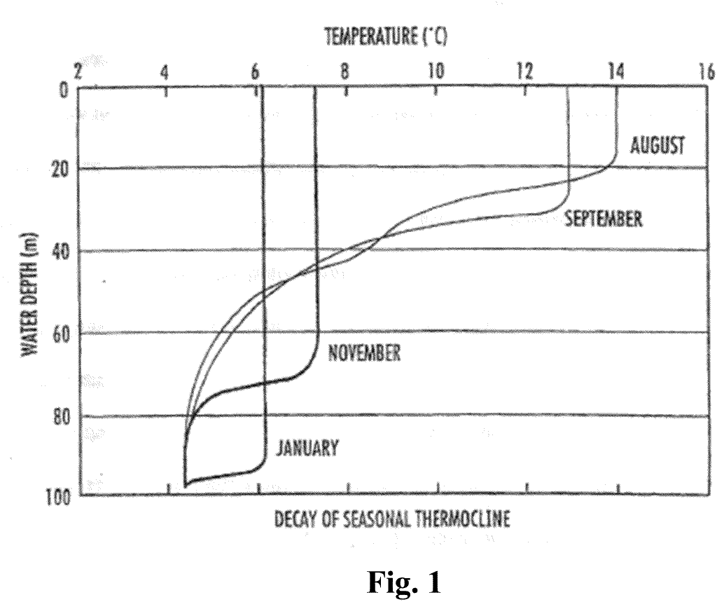

The world’s oceans and seas typically have temperature versus depth profiles that can be characterized generally as shown in FIG. 1 for the Northern hemisphere. For example, the upper layer is usually at a uniform temperature. The temperature is determined by the intensity and duration of solar radiation, as well as the efficiency of wind driven surface driven mixing. Although the depth of the upper layer varies depending on the season, a nominal depth for the upper layer is approximately 20-25 meters. Deeper water is colder than the upper layer. The transition region between upper and lower layers is referred to as the thermocline. The thermocline has a nominal thickness of approximately 20 meters. Although these dimensions vary with time of year and geographic location, as shown in FIG. 1, the numbers presented are illustrative.

Hurricanes, cyclones, tropical cyclones all various names for the intense highly costly and prolonged deadly storms that appear in the tropical oceans that are found in the Atlantic, Pacific, and Indian seas. Cyclonic activity is counterclockwise in the northern hemisphere and clockwise in the southern hemisphere. A fully developed cyclone is approximately a circular warm cored vortex that rises hundreds of kilometers, well into the troposphere. It may be likened to the movement of a circular vortex, that rotates with a relatively constant angular velocity. Hurricanes produce the most severe weather conditions known to man. Although it has been well studied, it is cyclogenesis cannot be regarded as fully understood. The track of a hurricane is determined by local weather conditions, and some success has been achieved in predicting the track from this knowledge, based on computational fluid mechanics.

As the atmospheric hurricane moves on its track across an expanse of ocean an intense swirl is formed below the as yet undisturbed ocean. This produces an intense, hundred percent humid spray that is loaded with warm water droplets. The fate of the spray resembles the well-known dry air thermodynamic adiabatic dry air dynamics, which with the addition of latent heat from the water droplets produces the great vertical ascent described above. The vortex draws the upward flow into it center, and finally it produces currents reaching the troposphere and lower stratosphere. This has been referred to as the in-up-out trajectory (Fletcher 1954). This description is also a precursor of the suggestion that a hurricane may be regarded as a Carnot cycle (Emanuel 2005; Emanuel 1991).

Evidence for the generation of a hurricane spray is abundant, even to the extent of meteorological observations taken by research ships that navigated through several tropical cyclones (Peterson, Black, and Pudov). An authoritative study of the role of spray in the genesis of cyclones has been presented by the renowned James Lighthill (Sir Lighthill 1998), also see the highly influential survey and overview in terms of the fluid dynamical aspects of cyclones by Ooyama (Ooyama 1982).

It is well-known that North America hurricanes originate in tropical storms spawned in the tropical waters off the west coast of Africa. It also is understood that the originating tropical storms, and the hurricanes that develop from them, are fueled by the energy content of the warm, upper layers of the ocean. There is correlation between the frequency and strength of such storms and the energy of those upper, warm layers of the ocean. Decreasing the temperature of this upper layer of ocean water diminishes the occurrence and intensity of tropical storms.

Gray (1979), summarizes conditions deemed necessary, thermodynamic, and mechanical, in order to generate and sustain a hurricane in the atmosphere. The key condition is that the ocean surface layer must be at least 26° C., in order to provide sufficient latent-heat input to sustain cyclonic activity. Gallacher et al (1989), and Emanuel (1989), indicate that “a 2.5° C. decrease in temperature near the core of the storm (hurricane) would suffice to shut down energy production entirely”. At ocean depths below the surface layer (^{~} 20 m) the thermocline begins and leads to a near limitless supply of very cold ocean water. Nominally, the deep cold ocean water is only 0.2% denser than the warm surface layer of ocean. Thus, relatively little work is required to lift the cold water to the surface. A central idea discussed in Applicant’s U.S. Pat. No. 8,262,314 is that deep cold ocean water can be used to cool the surface layer along the hurricane path in order to diminish the intensity of an evolving hurricane.

### Introduction

Hurricanes are fueled by inflow of energetic ocean spray, collected at the sea surface, into the low-pressure core of the hurricane eye. This provides energy that escalates the cyclonically upward spiraling of the resulting intense atmospheric vortex. The overall process has been likened to a Carnot cycle (Emanuel 2003; Emanuel 1991). Beyond this, the hurricane ismeteorologically steered dynamically by the ambient atmosphere. A true depiction of hurricanes requires consideration of oceanography and atmospheric interaction, (Pedlosky 2013). The present investigation explores methods which interfere with the fueling role of the ocean, in contrast to the high-profile, meteorological (seeding) attempts for altering hurricanes, of the last century, termed STORMFURY (Willoughby et al. 1985), that were deemed to be a failure.

Any attempt to modify this monster might seem foolhardy. Nevertheless, a hurricane on reaching landfall is removed from its energy source, and undergoes a steady decrease in intensity. Hurricane intensity is measured by maximal hurricane velocity, Vₘ, and modeled by (Kaplan and DeMaria 2001),

$$\frac{d {V}_{m}}{d t} = - \frac{{V}_{m}}{τ} ; τ \approx 10 h r .$$

Thus, 10 hours after landfall, the strength of a hurricane falls by more than half. It is an empiricalfact that a hurricane cannot form unless the sea surface temperature (SST) is greater than 26° C., (Gray 1979). The possibility of cooling, a portion of its track, in advance of hurricane arrival, will be investigated.

Simply lifting cold ocean water to the surface is inadequate for cooling the surface layer since the prevailing stratification will restore the colder ocean water to its appropriate depth, with negligible mixing. Thorough mixing of the warm surface layer with the deep cool ocean water will be required to produce a new cooler surface layer. Turbulent mixing is the optimal method for achieving the mixing of the warmer surface and cooler thermocline layers.

### Lower Bound on Work for Cyclonic Management

A representative calculation will be performed for a North Atlantic hurricane case.

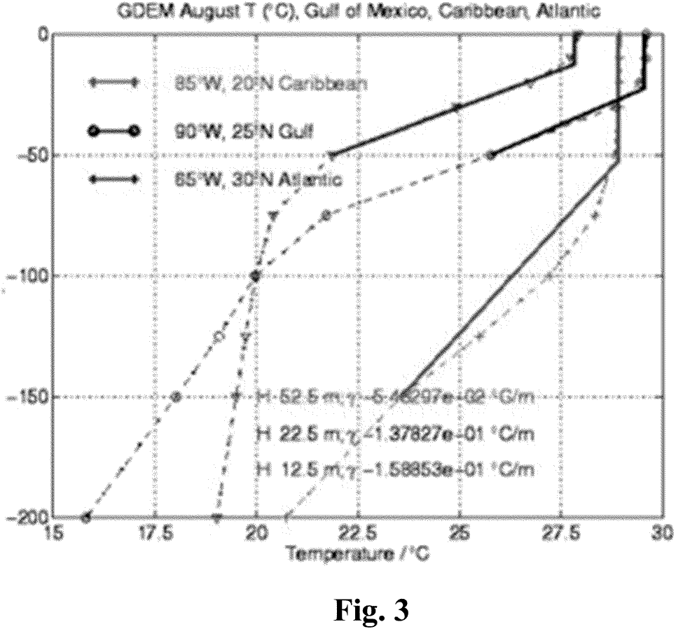

FIG. 3 shows three examples of ocean temperature variations in the Atlantic profile (east of Georgia/Florida).

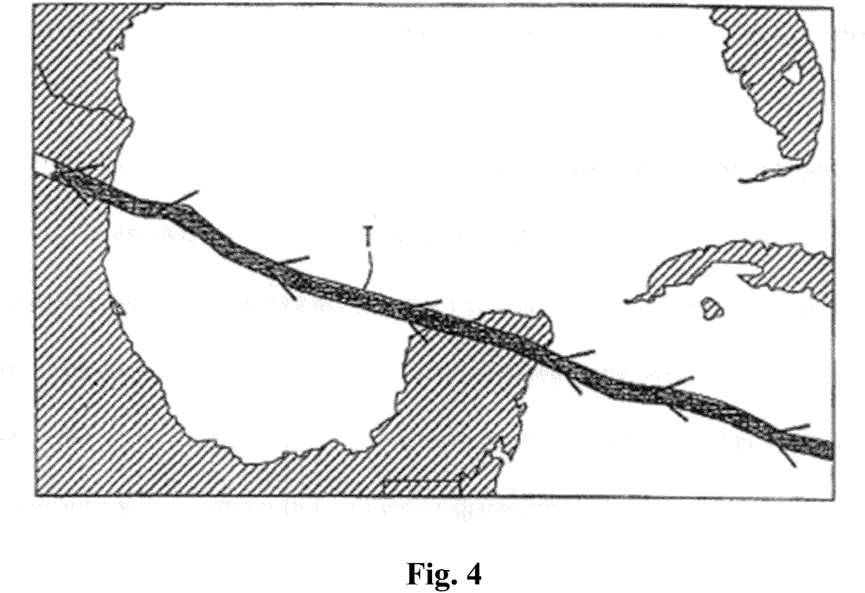

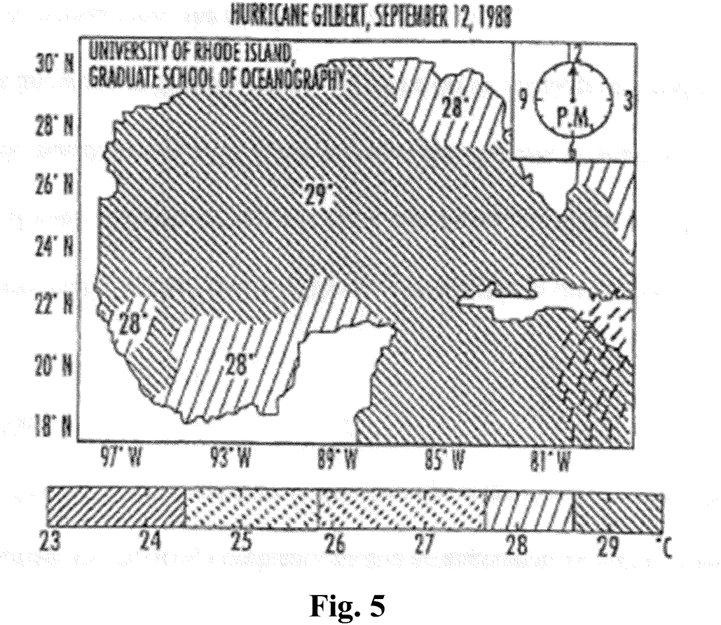

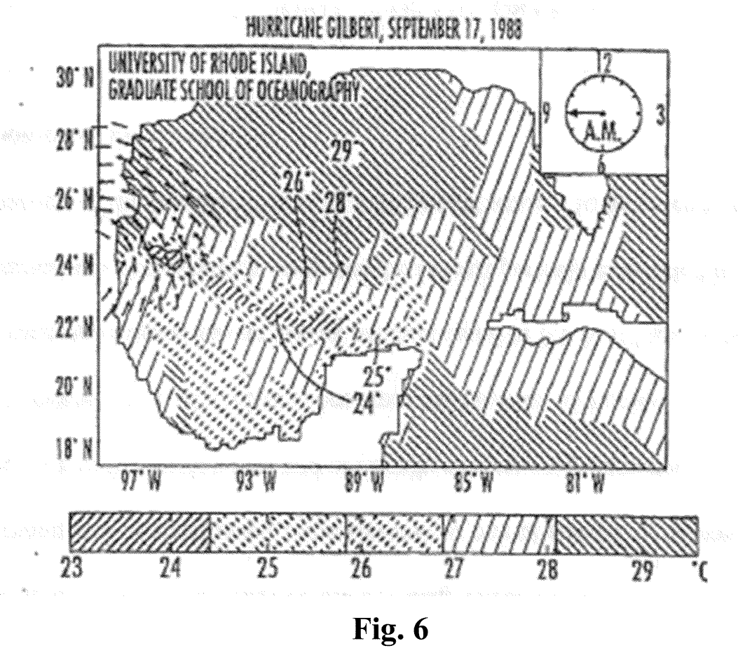

A concern might be whether cooling would persist long enough to be effective. Support for the efficacy of the above mixing approach to ocean cooling comes from sea surface imagery of hurricanes. A consequence of a hurricane passing over an ocean is that it performs the same type of ocean mixing that is proposed to achieve. FIG. 4 illustrates the path or course of the 1998 Hurricane Gilbert, moving from East to West from the Caribbean over the Yucatan Peninsula into the Gulf of Mexico before the landfall over Mexico. In FIG. 5 and FIG. 6 sea surface temperature images are shown acquired for the 1988 hurricane Gilbert as it passed over the Yucatan into the Gulf of Mexico (a full file is obtainable from the University of Rhode Island). Referring to FIG. 5, the sea surface temperatures roughly a day before the track passes over the Yucatan. Thus, on Sep. 12, 1998, the body of water to be traversed by Hurricane Gilbert was approximately 29° C. and some coastal regions approximately 28° C. Referring to FIG. 6, the Sea surface temperatures four days later are shown in FIG. 5, where temperatures along the track of the eye of the hurricane dropped 4-5° C. to 24-25° C. and the water adjoining the track dropped approximately 3° C. to 26° C. The considerable lateral spread, and the persistence of cooling is clear from the imagery. Concern about the temporal persistence of ocean cooling is certainly dispelled. Clearly four days after the passing of the hurricane, the sea surface layer remains well cooled.

The dynamical description of atmospheric hurricanes, (cyclones), is complex, and involves the thermodynamics of wet air, dissipative effects, and a three-dimensional geometry that extends from the ocean surface to the troposphere. This cannot take place without suitable ocean conditions.

There are two essential elements for cyclone initiation: (1) sufficient ocean circulation, originating in the Earth’s rotation, and; (2) adequate fueling by a warm ocean surface layer. Regarding the first of these it should be observed that the earth rotates in counterclockwise manner in the northern hemisphere (clockwise in the southern hemisphere), with rotation rate, Ω, given by,

$$\text{Ω} = 7.3 \times {10}^{- 5} r a d ⋅ {s}^{- 1}$$

where and how this is going to go is seemingly small, but indispensable to a cyclonic event. True local rotation depends on latitude, at the equator there is almost no circulation at the equator, so equatorial cyclones are rare.

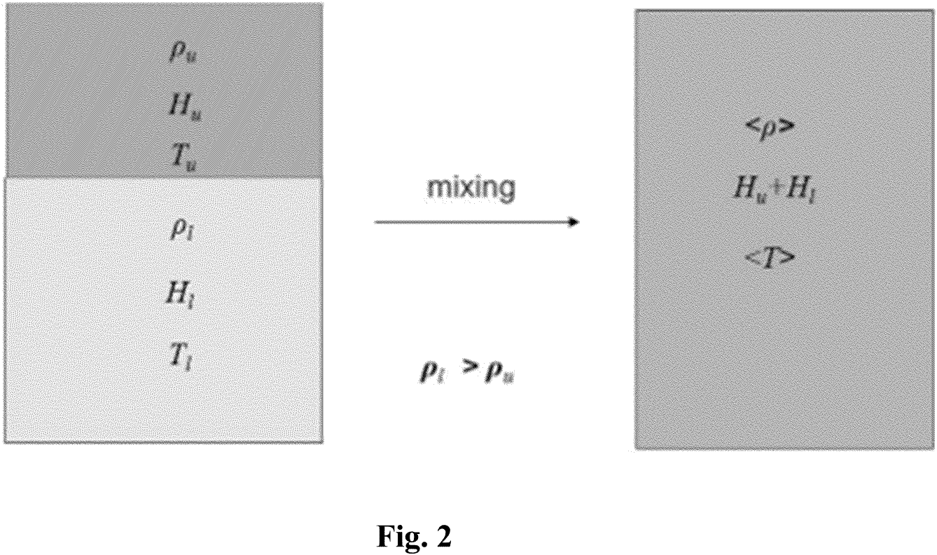

Consider a square meter cross-section column of seawater spanning the surface layer and thermocline, FIG. 2, left. The aim is to mix the column, to obtain the lower temperature uniform column shown at the right. The argument is informal, based on reasonable estimates.

Referring to FIG. 2, for constant heat capacity, the temperature of the mixed state is considered for,

$${T}_{u} - \left〈T\right〉 \approx 5 ° C ,$$

a decrease greater than usually needed to reduce the surface layer below 26° C.

The difference in potential energies of the two columns of FIG. 2 represents the absolute minimal needed work, W, to obtain the mixed state,

$$W / {m}^{2} = \left({ρ}_{l} - {ρ}_{u}\right) g \frac{{H}_{u} {H}_{l}}{2} ,$$

which for ρᵢ = 1027 kg / m³& ρᵤ =1025 kg / m³ yields

$$W / {m}^{2} = {10}^{4} J o u l e s .$$

Emphasis on minimal since it is the absolute lower bound of required work, analogous to the role played by a Carnot cycle in thermodynamics. As will be seen, it is an acceptable ballpark estimate of the true work needed.

To underline the nature of this result, note that (5) is roughly the energy needed to illuminate a 200 W bulb for a minute. This calculation, key to further considerations, informs us that since,

$$ε = \left({ρ}_{l} - {ρ}_{u}\right) / {ρ}_{l} ≫ .2 \% ,$$

relatively little work is required for mixing. As discussed below an extremely high COP (coefficient of performance) is responsible for this outcome. Also see (Winters et al. 1995).

### Hurricane Mitigation

(Gallacher, Rotunno, and Emanuel 1989) report that “a 2.5° C. decrease in temperature near the core of the storm (hurricane) would suffice to shut down energy production entirely”. Nominal values for hurricane speed and eye diameter are 20 km/h and 50 km., respectively. A reasonable guess for nuclear submarine speed, is ~67-83 km/h. From these estimates, and hurricane forecasting, it is certain that a submarine pack can intercept and in a timely manner laydown a carpet of cold ocean layer to diminish the intensity of the oncoming cyclones. For example, to create virtual landfall, 10 hours before true landfall, the track area of 50 km × 200 km ≈10¹⁰ m² would require,

$$\overline{W} = {10}^{14} J o u l e s ,$$

of energy to cool it by 5° C. While the extent of a hurricane might be 1000 km, it is fueled by an ocean area of diameter 50 km, a ratio of 1/20, which will figure in modeling estimates. Since sub speeds are roughly 4 times hurricane speeds, forecast uncertainties become less consequential.

As an example, the Russian Shark class nuclear submarine, has a power rating of ≈2× 10⁸ Joules/sec (Naval-Technology.com 2011). This is equivalent to the output of a small city power station; thus, a nuclear submarine can be viewed as an ocean going power station. For the 10 hours (=3.6× 10⁴ sec.) duration needed to create the virtual landfall, this amounts to a total energy of ≈ 10¹³Joules. It follows from (7) that 10 submarines might be required to create thevirtual landfall.

### Turbulent Mixing

Cold sea water, raised from the depths, if released at the sea surface, falls back to its natural level, unless quickly mixed, say by turbulence, the most efficient mixer. Based on typical US nuclear submarine specifications (Virginia and Ohio class), a sub’s beam is about 40 feet and the speed estimate ~67-83 km/h. Thus, a typical Reynolds number, Re, is

$$R e = O \left({10}^{8}\right) ,$$

which implies a fully turbulent wake starting with a 14 m stern.

### Hurricanes Costs

Wind forces are proportional to

$${V}_{m}^{2} ,$$

however, hurricane damage is proportional to the rate of work, i.e., power, hence proportional to

$${V}_{m}^{3} .$$

This key distinction suggests that if Vₘ is diminished by 20%, costs are halved!

Estimated hurricane costs to world economies can vary from tens of billions to tens of trillionsof dollars, depending on the criteria used in the studies (Kahn 2014; Mendelsohn and Saher 2011). Hence, reducing costs by half takes on profound economic significance.

### Coefficient of Performance

Elementary thermodynamic arguments (Fermi 1956) show that for the nominal 50 km × 200 kmocean area, and a modest depth of 20 meters, to be cooled by 5° C., not by mixing, but by heat removal of a Carnot cycle, requires an energy,

$$d E \approx 4 \times {10}^{18} J .$$

On the other hand, the above deliberations accomplish this by making use of available deep coldwater, lifted, and mixed with the warm surface water, compared with work, W̅.

This implies that the coefficient of performance is

$$C O {P}_{c o o l} = d E / \overline{W} \approx 10 , 000.$$

This is extraordinary compared to a COP of 2 or 3 for a conventional heat pump. At the heart ofthis energy leverage is the slight increase in ocean density with depth, (9).

### Improved Work Estimate

The calculation of

$$\overline{W} ,$$

(7), represents is the minimal required work Elementary dimensional reasoning shows that the true work needed, W_{T}, has the functional form,

$${W}_{T} / \overline{W} = f \left(ε , Re\right) ,$$

where,

$$ε = \frac{{ρ}_{l} - {ρ}_{u}}{\left〈ρ\right〉} \left(\approx \frac{{T}_{u} - {T}_{l}}{\left〈T\right〉}\right) ,$$

measures the gradient, and Re is the Reynolds Number. It follows from (9) and (11) that (14) should be considered for _{ε} ↓ 0& Re ↑ ∞, in which case (14) becomes

$${W}_{T} ε \times \overline{W} ,$$

under a smoothness assumption on f.

A useful guide in these deliberations is the case of a passive scalar, e.g., a dye, in which case full mixing occurs, in the presence of turbulence, without additional work (Sreenivasan 1991). In view of (6), density differences are tiny, and as such are akin to a passive scalar, in which case mixing comes for free. This, and other examples of dimensional reasoning suggests that (13) is unlikely to be off by more than a factor of 2. In the absence of experiment, this is the only support for estimates on the power needed for hurricane management.

### Submarine Modification

Submarine design is influenced by stealth demands, i.e., the need to avoid wake detection by satellite imaging. The present application is free of this restraint, and on the contrary a large wake is desirable.

It is proposed that the submarine modification include a variable diameter propeller, possibly aslarge as the beam diameter of Do~40 feet, to enable the action of fully developed turbulence across the wake.

Wake growth, D, with distance downstream, X, is given by D / Do = 1.25 × (X / Do)^{.22}, an empirical formula (MERRITT 1972) . This predicts that after one sub length, ~150 m, the wake diameter is ~33 m. Under this scenario, the work done in lifting the heavier deep oceanwater is subsumed by turbulence.

### Quelling of Tropical Depressions

Tropical depressions are storms of limited extent and strength, that are regarded as hurricane risks, routinely monitored by NOAA. Thus, an alternate strategy might be to dispatch submarines from well-chosen locations, with the mission of removing the potential storm threat. For example, hurricane Dorian, was recognized as a tropical depression, on Aug. 23, 2019; a week later it exhibited cyclonic potential. To explore what might have been done in the intervening week, in simplest terms, involves consideration of vortex motion on a rotating sphere (Newton 2013).

The Euler equations for a frame rotating with angular velocity, are given by,

$$ρ \frac{d \vec{u}}{d t} + ∇ p = ρ \left(∇ \frac{1}{2} {\left|\vec{\text{Ω}} \times \vec{r}\right|}^{2} - 2 \vec{\text{Ω}} \times \vec{u}\right) ,$$

(Kageyama and Hyodo 2006; Pedlosky 2013) where the 2 terms on the right-hand side represent the centripetal and Coriolis accelerations. For the earth’s northern is a vector pointing north, can of magnitude

$$W = 7. {3}^{′} {10}^{- 5} r a d \times {s}^{- 1} .$$

The “Coriolis force” points rightward from the of flow direction u; towards the right bank in thenorthern hemisphere.

To model the surface layer of the ocean, ignore vertical motion and consider the tangent plane z=0. This is given by the polar form of (18),

$$\begin{matrix}C : \frac{\partial r {u}_{r}}{\partial r} + \frac{\partial {u}_{θ}}{{\partial }_{θ}} = 0 \\ {M}_{r} : \frac{\partial {u}_{r}}{\partial t} + {u}_{r} \frac{\partial {u}_{r}}{\partial r} - \frac{{u}_{θ}^{2}}{r} + \frac{1}{ρ} \frac{\partial p}{\partial r} = 2 {\text{Ω}}_{o}^{2} r - 2 {\text{Ω}}_{o} {u}_{θ} \\ {M}_{θ} : \frac{\partial {u}_{θ}}{\partial t} + {u}_{r} \frac{\partial {u}_{θ}}{\partial r} + \frac{{u}_{r} {u}_{θ}}{r} = 2 {\text{Ω}}_{o} {u}_{r} ,\end{matrix}$$

Consider the steady solution of (20), as given by,

$$\begin{matrix}{u}_{θ} = {\text{Ω}}_{o} r + β / r , \\ {u}_{r} = α / r , \\ \frac{1}{ρ} \frac{\partial p}{\partial r} = - \left(\frac{\partial }{\partial r} \left({u}_{r}^{2} / 2\right) - \frac{{u}_{θ}^{2}}{r}\right) .\end{matrix}$$

where Ωo = Ωsin φ is the local latitudinal rotation rate, in the absence of vertical motion.

The first term of u_{θ}is the relevant uniform rotation and (α, β), of units ℓ²/twhere ℓis length and tis time, are source strengths, to bediscussed below.

As an illustration suppose β= 0, then streamlines correspond to a source, at the origin, and thecurvature of the streamlines due to the Coriolis acceleration. The stream function, from (17) in dimensionless form, is given by

$$ψ = α θ - \frac{{\text{Ω}}_{o} {r}^{2}}{2} .$$

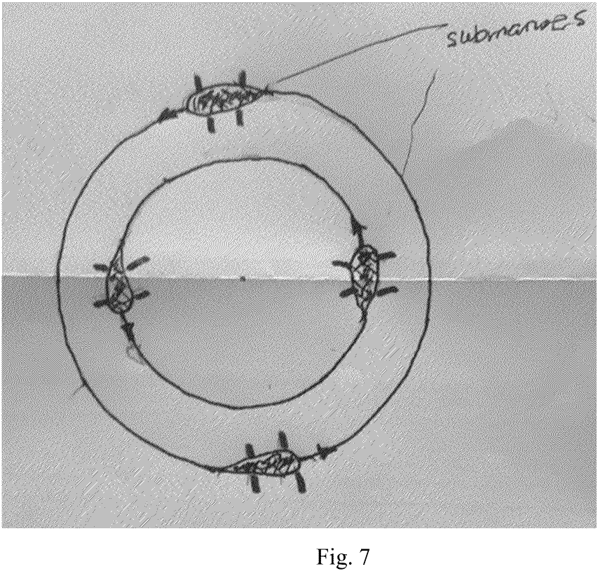

An exemplar of the stream function (20) is shown in FIG. 7.

$$ψ = θ + \frac{{\text{Ω}}_{o} {r}^{2}}{2 k} .$$

Thus, a novel fluid solution has been derived. This solution describes flow in terms of the radial variable, r, measured from the calculated center of the tropical depression, r_{c}=(x_{c},y_{c}). Thus, the flow contains 5 parameters, α, β, r_{c} and Ω. The last is just the local spin of the earth, determined by the latitude. There are parameters are determined by a best fit (in the sense of the least squares) to the actual NOAA data of the tropical depression.

While the extent of a hurricane might be 1000 km, it is fueled by an ocean area of diameter 50 km, a ratio of 1/20, which serves as a general basis of estimate. In general a tropical storm is of limited size, perhaps, less than 200 km in diameter, more or less. As indicated above, only a circular area less than 20 km, need be cooled by the deeper ocean. This suggests that less than 5 submarines would be more than adequate for the weakening and perhaps squelching of the tropical storm. The submarine pack should induce cyclonic circulation around the above determined center of the tropical storm. Forecasting of the incipient storm by NOAA, could guide the submarine pack over time. Since submarines travel with the speed that is roughly 4 times that of a normal hurricane speed, errors in forecasting are easily remedied. For the application of producing rainfall, similar procedures can be followed, with the exception that the submarine path should induce anti-cyclonic circulation.

For practical application, a NOAA snapshot of a tropical depression is fit to the model, (17). Thus, the data furnishes α and β as well as the center location, and hence an analytical shape is conferred on the tropical depression. In keeping with the general theme, to inhibit the cyclonic development, the surface layer should be cooled by mixing. Since a tropical depression is small ~O(10² )km, only a small region, say of diameter 20 km, around the now known center, as suggested below (10), need be mixed, and few submarines are required.

This effect is augmented if the submarine pack executes a circular, cyclonic annular band around the origin, which due to the Coriolis force, allows additional cold water to be lifted to the surface. Additionally, can aerodynamically, steer the atmospheric storm system northward, which is desirable since disturbances north of the 20^{th} latitude rarely develop into cyclones (Knaff et al. 2013; Knaff, Longmore, and Molenar 2014). At more northerly latitudes the surface layer becomes cooler, and a greater Coriolis force pumps deeper water to the surface.

This strategy clearly diminishes moisture accumulation, hence even if the storm is not squelched, less rainfall accompanies the hurricane.

The National Oceanographic and Atmospheric Administration (NOAA) oversees a broad range of data acquiring remote sensing facilities, and thereby monitors the world’s atmospheric and oceanographic conditions in a range of frequencies. As part of this effort tropical depressions are routinely reported, and their tracks predicted, since they are regarded as precursors of atmospheric storms and in particular cyclones. For example, hurricane Dorian was observed as a low-pressure zone as early as Aug. 19, 2019, and by August 22 it was reported to be a low-pressure threat, and then designated to be a tropical depression on August 24, when it was more than 800 miles away from the island of Barbados. When tropical storm Dorian struck Barbados, on August 27, it did so with sustained maximal winds of 50 mph, below the criterion to be a cyclone. On September 1 it struck Elbow Cay with winds having a maximal intensity of 185 mph, a category 5 hurricane.

Hurricanes originating in the Caribbean basin are overwhelmingly more frequent than from elsewhere. For this reason, it is suggested that a naval station outfitted for servicing nuclear submarines and other possible vessels be established at an optimally chosen Caribbean location. Had such a facility been in existence at the time of Dorian, a pack of submarines could have been dispatched and reached areas of potential threat in less than one day to deal with the situation. The overall idea is to have the submarines execute maneuvers along the projected track that would counteract and interfere with the normal cyclonic activity that draws energy from the ocean surface layer to produce the cyclonic vortex, and that further fuels the intensity of cyclonic motion.

The first stage of this strategy requires track prediction of the potential storm, which is simply a matter of weather prediction, based on the known local conditions. Weather prediction and in particular storm tracking, based on ambient conditions is routinely carried out and the data provided by NOAA. NOAA in fact maintains a network of computing facilities dedicated to high-level geophysical fluid dynamical calculations, and their collaboration would play an important role in the activities that are being proposed.

An important conceptual element in the following discussion is that two different, immense, entities are involved; the atmospheric hurricane, and the effect that this produces on the ocean. Conceptually, the atmospheric hurricane can be visualized as a wave that passes over the larger ocean.

As a first step, submarines should be positioned on the hurricane track in a zone where the storm would, for example, appear roughly twelve hours later. Based on the projected weather, a center of the storm can be determined, as well as the amount of projected swirl. All of this is calculated based on a projection twelve hours in the future. Based on procedures and algorithms that will be specified below, the submarine pack embarks on well specified maneuvers that produce properly placed oceanic swirl equal to what the atmospheric swirl that would hit this zone, 12 hours in the future. Thus, a minimization of the intensity and span of the frictional zone between atmosphere and ocean is achieved, as is the de facto amount of spray. Hence, the fueling of the storm center is inhibited, and the goal of diminishing the intensity is also achieved.

At this first stage, the potential for storm development can be reassessed, and if necessary, this strategy is repeated, and so on until the storm no longer possesses a potential for causing any serious consequences.

### Swirling Procedure

The swirling of the surface layer need not be performed deeply, perhaps no more than a foot or a meter of depth from the surface. Once the swirl made by the submarines is established they can leave for their next task. Once swirling has been established it should be relatively long-lasting, since frictional effects are quite weak, a consequence of the very low viscosity of water.

Next, we illustrate the procedure for the case of the northern hemisphere in which case the tropical depression or storm appears as a counterclockwise rotation, that is determined by the latitudinal location of the disturbance, as are the local meteorological conditions, as available from remote sensing.

As an aside it should be noted that the counterclockwise induced motion in the surface layer produces a Coriolis force which is radially outward, and therefore this induces source flow in the ocean layer, thus drawing up deep cold ocean that cools the surface layer. This is clearly a welcome positive feedback in suppressing the potential cyclone.

FIG. 7 illustrates a possible submarine pack configuration for inducing ocean swirling, on the basis of a nominal grouping 10 of four nuclear subs 12, 14, 16, 18. The needed amount of swirling and area of swirling is to be determined by the forecasted conditions. The use of four submarines is nominal and indicates how to accommodate any number of submarines. The shaded tear drops represent submarines, and as the arrows 20 indicate these are all moving anti-cyclonically or counterclockwise. The circular vortical structure of a hurricane moves in a uniform manner, i.e. the angular velocity of each submarine is the same constant. The heavy short lines perpendicular to the submarines indicate airfoils 22, and the angle of attack of the airfoils 22 is perpendicular to the motion. The purpose of the assembly of submarines is to entrain as much of the ocean to move anti-cyclonically in the chosen circular patch of predetermined center and radius. This is a nominal figure, and the number of submarines is determined by the forecast conditions. As mentioned in the text the depth of rotation can be relatively small. A meter depth is likely more than enough. Variations in the manner of deployment is a matter of experimentation. A variation might be cables connecting submarines (Since a turntable motion is be modeled, the assembly plus the cables represent a solid body in rotation is being modeled cable length is not a problem). With perhaps a short curtain attached to the cables. Another possibility would be the additional use of marine drones.

The procedure just described should be regarded as part of a stepwise strategy. Remote-sensing of the area will inform us of the new track conditions, and therefore whether a potential threat still exists, and if necessary the above strategy is repeated, as many times as is needed until the storm threat is removed.

### Rainfall Generation

The above deliberations might, in a manner of speaking, be reversed to induce storm generation to produce rainfall under circumstances that are suitable for such a tactic. For this to occur, it must be first determined if the local conditions will carry an induced storm to the appropriate location in need of rainfall. For simplicity we again suppose that the situation is in the northern hemisphere. Again, submarines are dispatched to an area deemed suitable for producing a storm that will be helpful in producing rainfall. Now the goal is to increase the production of spray, and therefore the submarine pack that is now in the path of the weather system executes anti-cyclonic, clockwise swirl in the oncoming area of the weather system, as predicted by means of the geophysical fluid flow laboratories. This results in a greater differential between atmospheric and ocean swirl, and hence is a producer of spray. Additionally, the anti-cyclonic motion induces a Coriolis effect which draws in surface fluid to the center of motion, which in this case becomes a sink, thus drawing in warmer sea water, thus furnishing a positive feedback effect for production cyclo-genesis.

Thus, a reversal of the above simple reasoning leads to a method which would enhance hurricane initiation, for the purpose of increasing rainfall. Since cyclonic swirling in the Northern and Southern hemispheres are in opposite directions, the directions of cyclonic and anti-cyclonic ocean and atmospheric swirls and vessel circulatory movements are as follows:

| | | |
|---|---|---|
| DIRECTION OF MOVEMENT | NORTHERN HEMISPHERE | SOUTHERN HEMISPHERE |
| Cyclonic | Counter-Clockwise | Clockwise |
| Anti-Cyclonic | Clockwise | Counter-Clockwise |

The direction of movement is the circular or annular movement about the center of a tropical depression.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of mitigating the formation of a potential hurricane comprising the steps of:
(a) on detection of a tropical depression moving in a known direction and having a center and predetermined radius within which there is an atmospheric swirl in a predetermined cyclonic direction resulting in the formation of spray rising from the ocean surface into the atmosphere;
(b) dispatching a plurality of vessels modified for stirring and mixing ocean water;
(c) causing said plurality of vessels to undertake a cyclonic flow in a direction that is the same as said predetermined direction in an annular band of circulation substantially corresponding to said predetermined radius around said center of the tropical depression to cause cooling through mixing and Coriolis lift to diminish surface ocean temperature and spray rising into the atmosphere; and
(d) continuing said activity while following said center of said tropical depression along said known direction until the threat of a hurricane is eliminated.

2. A method as defined in claim 1, further comprising maintaining bases or stations for said plurality of vessels at locations placed with respect to high risk regions where low pressure systems or tropical storms or cyclones frequently form.

3. A method of enhancing the formation of a hurricane or precipitation comprising the steps of
(a) on detection of conditions conducive for storm generation or production of rainfall under circumstances of a tropical depression moving in a known direction and having a center and predetermined radius within which there is an atmospheric swirl resulting in the formation of spray rising from the ocean surface into the atmosphere in a predetermined cyclonic direction;
(b) dispatching a plurality of vessels modified for stirring and mixing ocean water;
(c) causing said plurality of vessels to undertake an anti-cyclonic flow in a direction that is in a direction that is opposite to said predetermined cyclonic direction in an annular band of circulation substantially corresponding to said predetermined radius around said center of the tropical depression to cause warm ocean water to be drawn towards the center of the tropical depression as a result of Coriolis lift to maintain the surface ocean temperature and increase ocean spray rising into the atmosphere; and
(d) continuing said activity to enhance the creation of rainfall or a storm.
